(19) United States
(12) Patent Application Publication
(10) Pub. No.: US 2012/0209492 A1
(43) Pub. Date: Aug. 16, 2012

(54) METHOD OF REGULATING ACCELERATION CONTROL AND ADAPTIVE CRUISE CONTROL SYSTEM FOR THE SAME

(76) Inventor: Jae Bum CHOI, Seoul (KR)

(21) Appl. No.: 13/398,141

(22) Filed: Feb. 16, 2012

(30) Foreign Application Priority Data
Feb. 16, 2011 (KR) 10-2011-0013823

(51) Int. Cl. B60K 31/00

(52) U.S. Cl. 701/96

(57) ABSTRACT

A method of regulating acceleration control and an adaptive cruise control system for the same are provided. The type of change of a travel situation of a vehicle is identified and acceleration control is regulated differently according to the identified type.

### CROSS-REFERENCE TO RELATED APPLICATION(S)

This application claims the benefit of Korean Patent Application No. 2011-0013823, filed on Feb. 16, 2011 in the Korean Intellectual Property Office, the disclosure of which is incorporated herein by reference.

### BACKGROUND

1. Field

Embodiments of the present invention relate to a method of regulating acceleration control and an adaptive cruise control system for the same wherein the type of change of a travel situation of a vehicle is identified and acceleration control is regulated differently according to the identified type.

2. Description of the Related Art

A conventional Adaptive Cruise Control (ACC) system automates acceleration and deceleration control of a vehicle while the vehicle is traveling to reduce the burden of the driver and to facilitate smooth traffic flow.

When the conventional ACC system performs acceleration control of the vehicle, the driver may sometimes feel anxious. For example, acceleration control is performed when a preceding vehicle which is traveling in the same lane as the vehicle in which the ACC system is mounted has changed lanes to an adjacent lane and a new preceding vehicle is not present in the same lane as the vehicle or is away from the vehicle. Such acceleration control may make the driver feel anxious since the acceleration control is abruptly performed regardless of the acceleration intention of the driver.

### SUMMARY

Therefore, it is an aspect of the present invention to provide a method of regulating acceleration control and an adaptive cruise control system for the same wherein the type of change of a travel situation of a vehicle is identified and acceleration control is regulated differently according to the identified type to assist in safe traveling.

Additional aspects of the invention will be set forth in part in the description which follows and, in part, will be obvious from the description, or may be learned by practice of the invention.

In accordance with one aspect of the present invention, an adaptive cruise control system includes a vehicle state information acquirer that acquires vehicle state information of a vehicle and preceding vehicle state information of a preceding vehicle that has been detected as being in the same lane as the vehicle, an acceleration/deceleration controller that performs acceleration control or deceleration control of the vehicle according to whether or not a new preceding vehicle is present in front of the vehicle or according to a distance between the vehicle and the new preceding vehicle after a situation in which the vehicle and the preceding vehicle are not in the same lane is detected according to the vehicle state information and the preceding vehicle state information, and an acceleration control regulator that determines whether the detected situation is a cut-out situation in which the preceding vehicle has changed lanes to an adjacent lane or a lane change situation in which the vehicle has changed lanes to an adjacent lane and regulates the time to start acceleration control or the extent of change of acceleration control according to the determination.

In accordance with another aspect of the present invention, an acceleration control regulation method provided by an adaptive cruise control system includes acquiring vehicle state information of a vehicle and preceding vehicle state information of a preceding vehicle that has been detected as being in the same lane as the vehicle, detecting a situation in which the vehicle and the preceding vehicle are not in the same lane according to the vehicle state information and the preceding vehicle state information, determining, when there is a need to perform acceleration control of the vehicle according to whether or not a new preceding vehicle is present in front of the vehicle or according to a distance between the vehicle and the new preceding vehicle after the situation is detected, whether the detected situation is a cut-out situation in which the preceding vehicle has changed lanes to an adjacent lane or a lane change situation in which the vehicle has changed lanes to an adjacent lane, and regulating the time to start acceleration control or the extent of change of acceleration control according to the determination.

According to the aspects of the present invention, the type of change of a travel situation of a vehicle is identified and acceleration control is regulated differently according to the identified type, thereby assisting in safe traveling.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a block diagram of an Adaptive Cruise Control (ACC) system according to an embodiment of the present invention;

FIG. 2 illustrates a cut-out situation and a lane change situation that are discriminated by the ACC system according to an embodiment of the present invention;

FIG. 3 illustrates a method in which the ACC system discriminates between a cut-out situation and a lane change situation according to an embodiment of the present invention;

FIG. 4 illustrates a method in which the ACC system regulates acceleration control according to an embodiment of the present invention; and

FIG. 5 is a flowchart of an acceleration regulation method provided by the ACC system according to an embodiment of the present invention.

### DETAILED DESCRIPTION

Embodiments of the present invention will now be described in detail with reference to the illustrative drawings. In the following description, the same elements will be denoted by the same reference numerals if possible although they are shown in different drawings. Further, in the following description, a detailed description of known functions and configurations incorporated herein will be omitted when it may obscure the subject matter of the present invention.

Terms such as first, second, A, B, (a), and (b) may be used to describe components of the embodiments of the present invention. These terms are merely used to discriminate between components without limiting the essence, order, sequence, or the like of the components. When it is stated that one component is “connected”, “coupled”, or “linked” to another component, it is to be understood that the two components may not only be directly “connected”, “coupled”, or “linked” but may also be indirectly “connected”, “coupled”, or “linked” via another component.

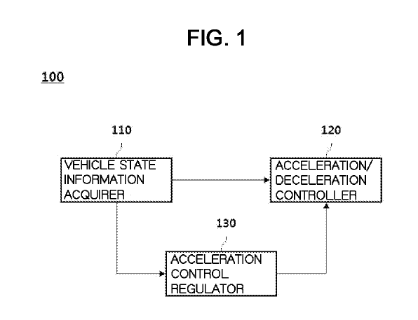

FIG. 1 is a block diagram of an Adaptive Cruise Control (ACC) system 100 according to an embodiment of the present invention.

As shown in FIG. 1, the ACC system 100 according to an embodiment of the present invention includes a vehicle state information acquirer 110 and an acceleration/deceleration controller 120. The vehicle state information acquirer 110 acquires vehicle state information of a vehicle and preceding vehicle state information of a preceding vehicle that is detected as being present in the same lane as the vehicle. After a situation in which the vehicle and the preceding vehicle are not in the same lane is detected according to the acquired vehicle state information and preceding vehicle state information, the acceleration/deceleration controller 120 performs acceleration control or deceleration control of the vehicle according to whether or not a new preceding vehicle is present in front of the vehicle or according to the distance between the vehicle and the preceding vehicle. In this specification, the term “vehicle” refers to the vehicle in which the ACC system 100 is mounted and the term “preceding vehicle” or “front vehicle” refers to another vehicle that is traveling in front of the “vehicle” in the same lane as the “vehicle”.

Specifically, when the vehicle or the preceding vehicle changes lanes to an adjacent lane while the vehicle is being controlled to travel along the same lane as the preceding vehicle, the ACC system 100 may perform deceleration control or acceleration control according to speed of a new preceding vehicle when the new preceding vehicle is present in front of the vehicle and may perform acceleration control when the new preceding vehicle is not present in front of the vehicle or when the new preceding vehicle is more than a predetermined distance away.

However, such acceleration control may be perceived as abrupt acceleration control by the driver, thus causing driver anxiety.

Thus, there is a need to perform a method of regulating acceleration control. The ACC system 100 according to an embodiment of the present invention provides such an acceleration control regulation method.

To accomplish this, the ACC system 100 according to an embodiment of the present invention may further include an acceleration control regulator 130 that regulates acceleration control that is performed by the acceleration/deceleration controller 120.

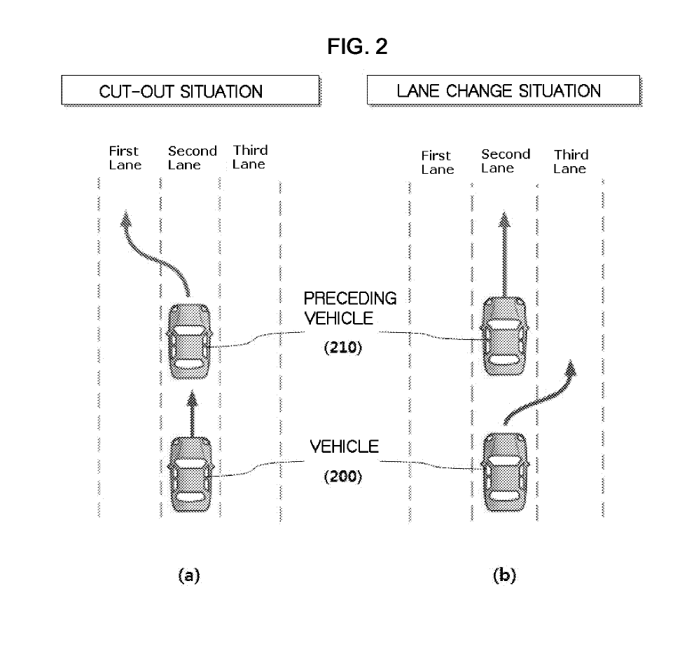

Before the acceleration control regulator 130 is described in detail, a situation, in which the vehicle or the preceding vehicle has changed lanes to an adjacent lane such that the vehicle and the preceding vehicle are not in the same lane, is described below with reference to FIG. 2.

As shown in FIG. 2, such a situation in which the vehicle 200 and the preceding vehicle 210 are not in the same lane occurs when one of the vehicle 200 and the preceding vehicle 210 changes lanes. Hereinafter, a situation in which the preceding vehicle 210 has changed lanes (from a 1st lane to a 2nd lane) as shown in FIG. 2(a) is referred to as a “cut-out situation” and a situation in which the vehicle 200 has changed lanes (from a 2nd lane to a 3rd lane) as shown in FIG. 2(b) is referred to as a “lane change situation”.

The acceleration control regulator 130 discriminates between the cut-out situation and the lane change situation and regulates acceleration control differently for each of the cut-out situation and the lane change situation.

Specifically, the acceleration control regulator 130 determines whether the detected situation, in which the vehicle or the preceding vehicle has changed lanes to an adjacent lane such that the vehicle and the preceding vehicle are not in the same lane, is the cut-out situation in which the preceding vehicle has changed lanes or the lane change situation in which the vehicle has changed lanes and regulates the time to start acceleration control or the extent of change of acceleration control according to such determination. Here, the cut-out situation corresponds to a situation in which the driver of the vehicle has no intention to accelerate and the lane change situation corresponds to a situation in which the driver of the vehicle has an intention to accelerate. Accordingly, when acceleration control is performed immediately after the lane change situation is detected, it is likely that the driver of the vehicle does not feel anxious due to such abrupt acceleration control since the driver already has an intention to accelerate. However, when acceleration control is performed immediately after the cut-out situation is detected, the driver of the vehicle may feel anxious due to such abrupt acceleration control.

For example, the acceleration/deceleration controller 120 may need to perform acceleration control of the vehicle upon detecting that a new preceding vehicle is not present in front of the vehicle or that a new preceding vehicle is more than a predetermined distance away after the situation, in which the vehicle or the preceding vehicle has changed lanes to an adjacent lane such that the vehicle and the preceding vehicle are not in the same lane, is detected according to the state information of the vehicle and the state information of the preceding vehicle. In this case, when the acceleration control regulator 130 determines that the situation in which the vehicle and the preceding vehicle are not in the same lane is the “cut-out situation” in which the preceding vehicle has changed lanes, the acceleration control regulator 130 may delay the time to start acceleration control that is to be performed by the acceleration/deceleration controller 120 or may set gradient information of such acceleration control to a lower value to reduce the extent of change (or the rate of change) of acceleration control.

On the other hand, when the acceleration control regulator 130 determines that the situation in which the vehicle and the preceding vehicle are not in the same lane is the “lane change situation” in which the vehicle has changed lanes, the acceleration control regulator 130 may prevent acceleration control from being performed by the acceleration/deceleration controller 120, may delay the time to start acceleration control, may prevent regulation of gradient information of acceleration control or may reduce the extent of such regulation.

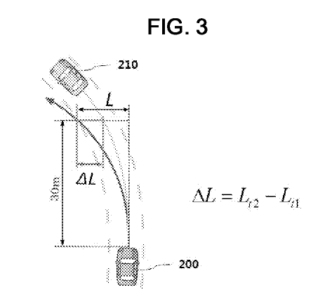

The vehicle state information acquirer 110 may further acquire the amount of change (ΔL=Lₜ₂−Lₜ₁) of the transversal position of the vehicle 200 as shown in FIG. 3 for a predetermined time (Δt=t2−t1). Here, the amount of change of the transversal position ΔL may be included in the vehicle state information.

Using the amount of change (ΔL=Lₜ₂−Lₜ₁) of the transversal position of the vehicle 200 acquired by the vehicle state information acquirer 110, the acceleration control regulator 130 determines whether the situation is the cut-out situation (in which the preceding vehicle has changed lanes) or the lane change situation (in which the vehicle has changed lanes).

For example, the acceleration control regulator 130 compares the acquired transversal position change amount ΔL with a reference transversal position change amount ΔL_{ref}. The acceleration control regulator 130 may determine that the situation is the cut-out situation in which the preceding vehicle 210 has changed lanes when the acquired transversal position change amount ΔL is less than or equal to the reference transversal position change amount ΔL_{ref} and determine that the situation is the lane change situation in which the vehicle 200 has changed lanes when the acquired transversal position change amount ΔL is greater than the reference transversal position change amount ΔL_{ref}.

Here, the reference transversal position change amount ΔL_{ref} may be a value that is preset differently depending on road curvature. For example, the reference transversal position change amount may be set to a lower value for a straight road and may be set to a high value for a curved road. That is, the reference transversal position change amount may be set to a higher value as road curvature increases (i.e., reference transversal position change amount ∝ road curvature).

As described above, the acceleration control regulator 130 may discriminate between the cut-out situation and the lane change situation and regulate acceleration control differently for each of the cut-out situation and the lane change situation.

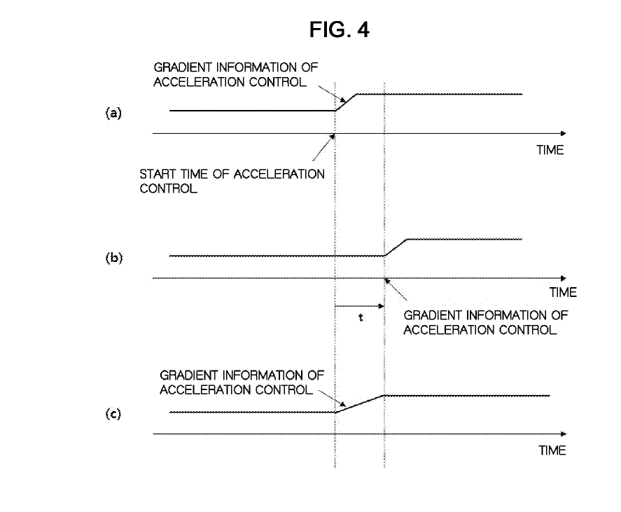

How the acceleration control regulator 130 performs acceleration control regulation upon detecting that a new preceding vehicle is not present in front of the vehicle or that a new preceding vehicle is more than a predetermined distance away after the cut-out situation is detected is described below with reference to FIG. 4.

FIG. 4(a) illustrates an example in which the acceleration control regulator 130 does not perform acceleration control regulation.

In contrast to FIG. 4(a), FIG. 4(b) illustrates a method of regulating acceleration control by delaying the time to start acceleration control. As shown in FIG. 4(b), the acceleration control regulator 130 may regulate acceleration control by delaying the time to start acceleration control that is to be performed by the acceleration/deceleration controller 120 by a predetermined time t.

In contrast to FIG. 4(a), FIG. 4(c) illustrates a method of regulating acceleration control by setting gradient information of acceleration control, which is to be performed by the acceleration/deceleration controller 120, to a lower value to reduce the extent of change (or the rate of change) of acceleration control.

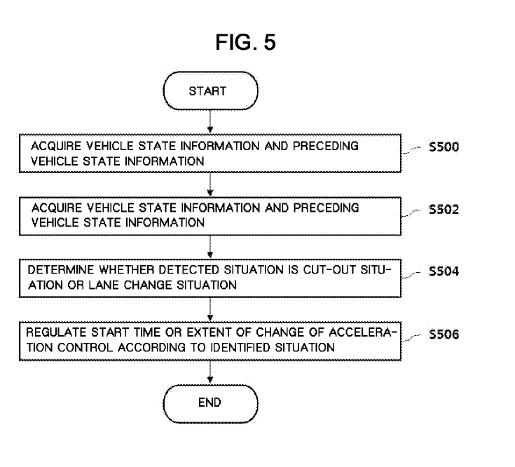

FIG. 5 is a flowchart of an acceleration regulation method provided by the ACC system 100 according to an embodiment of the present invention.

The acceleration regulation method provided by the ACC system 100 according to an embodiment of the present invention includes operation S500 to acquire vehicle state information of the vehicle and preceding vehicle state information of a preceding vehicle that has been detected as being in the same lane as the vehicle, operation S502 to detect a situation in which the vehicle and the preceding vehicle are not in the same lane (since the vehicle or the preceding vehicle has changed lanes) according to the acquired vehicle state information and preceding vehicle state information, operation S504 to determine whether the situation detected in operation S502 is a cut-out situation in which the preceding vehicle has changed lanes to an adjacent lane or a lane change situation in which the vehicle has changed lanes to an adjacent lane when there is a need to perform acceleration control of the vehicle according to whether or not a new preceding vehicle is present in front of the vehicle or according to a distance between the vehicle and the preceding vehicle after the situation in which the vehicle and the preceding vehicle are not in the same lane is detected in operation S502, and operation S506 to control the extent of change of acceleration control or the time to regulate acceleration control according to the determination of operation S504.

Upon determining in operation S504 that the situation detected in operation S502 is the cut-out situation, acceleration control may be performed by delaying the time to start acceleration control or setting gradient information of acceleration control to a lower value to reduce the extent of change of acceleration control.

As is apparent from the above description, the type of change of a travel situation of a vehicle is identified and acceleration control is regulated differently according to the identified type, thereby assisting in safe traveling.

In the above description, although the embodiments of the present invention may have been explained such that all components of the embodiments are operatively combined into one unit, embodiments of the present invention are not necessarily limited to such embodiments. Rather, within the objective scope of the present invention, the components may be selectively and operatively combined into two or more units. In addition, although each of the components may be implemented by one independent hardware module, all or part of the components may also be selectively combined and may then be implemented by a computer program having program modules that perform all or part of the functions of the combined components in one or more hardware modules. Codes and code segments that constitute the computer program will be easily derived by those skilled in the art of the invention. Such a computer program may be stored in computer readable media and may be read and executed by a computer to implement the embodiments of the present invention. The computer readable media may include magnetic recording media, optical recording media, and carrier wave media.

Further, terms such as “include”, “comprise”, or “have” should be interpreted as inclusive rather than exclusive unless specifically stated otherwise such that, when it is stated that a unit “includes”, “comprises”, or “has” one component, this implies that the unit may also include other components rather than excluding other components. All terms including technical or scientific terms used herein have the same meanings as generally understood by those skilled in the art unless defined otherwise. Common terms as defined in dictionaries should be interpreted in the context of the related art rather than being interpreted too ideally or formally unless clearly defined herein.

Although exemplary embodiments of the present invention have been described for illustrative purposes, those skilled in the art will appreciate that various modifications, additions and substitutions are possible without departing from essential characteristics of the invention. Thus, the embodiments described herein are explanatory without limiting the technical spirit of the invention and should not be used to limit the scope of the invention. The scope of the invention should be determined by reasonable interpretation of the appended claims and all changes coming within the equivalency range of the invention are intended to be embraced in the scope of the invention.

What is claimed is:

1. An adaptive cruise control system comprising:
a vehicle state information acquirer that acquires vehicle state information of a vehicle and preceding vehicle state information of a preceding vehicle that has been detected as being in the same lane as the vehicle;
an acceleration/deceleration controller that performs acceleration control or deceleration control of the vehicle according to whether or not a new preceding vehicle is present in front of the vehicle or according to a distance between the vehicle and the new preceding vehicle after a situation in which the vehicle and the preceding vehicle are not in the same lane is detected according to the vehicle state information and the preceding vehicle state information; and
an acceleration control regulator that determines whether the detected situation is a cut-out situation in which the preceding vehicle has changed lanes to an adjacent lane or a lane change situation in which the vehicle has changed lanes to an adjacent lane and regulates the time to start acceleration control or the extent of change of acceleration control according to the determination.

2. The adaptive cruise control system according to claim 1, wherein the vehicle state information acquirer further acquires a transversal position change amount of the vehicle for a predetermined time.

3. The adaptive cruise control system according to claim 2, wherein the acceleration control regulator compares the transversal position change amount with a reference transversal position change amount and determines that the detected situation is the cut-out situation when the transversal position change amount is less than or equal to the reference transversal position change amount and that the detected situation is the lane change situation when the transversal position change amount is greater than the reference transversal position change amount.

4. The adaptive cruise control system according to claim 3, wherein the reference transversal position change amount is a value that is preset differently according to road curvature.

5. The adaptive cruise control system according to claim 1, wherein the acceleration/deceleration controller performs acceleration control of the vehicle when a new preceding vehicle is not present in front of the vehicle or is more than a predetermined distance away after a situation in which the vehicle and the preceding vehicle are not in the same lane is detected according to the vehicle state information and the preceding vehicle state information.

6. The adaptive cruise control system according to claim 5, wherein, upon determining that the detected situation is the cut-out situation when the acceleration/deceleration controller needs to perform acceleration control of the vehicle, the acceleration control regulator delays the time to start the acceleration control or sets gradient information of the acceleration control to a lower value to reduce the extent of change of the acceleration control.

7. An acceleration control regulation method provided by an adaptive cruise control system, the method comprising:
acquiring vehicle state information of a vehicle and preceding vehicle state information of a preceding vehicle that has been detected as being in the same lane as the vehicle;
detecting a situation in which the vehicle and the preceding vehicle are not in the same lane according to the vehicle state information and the preceding vehicle state information;
determining, when there is a need to perform acceleration control of the vehicle according to whether or not a new preceding vehicle is present in front of the vehicle or according to a distance between the vehicle and the new preceding vehicle after the situation is detected, whether the detected situation is a cut-out situation in which the preceding vehicle has changed lanes to an adjacent lane or a lane change situation in which the vehicle has changed lanes to an adjacent lane; and
regulating the time to start acceleration control or the extent of change of acceleration control according to the determination.

8. The adaptive cruise control system according to claim 7, wherein the regulation comprises delaying, upon determining that the detected situation is the cut-out situation, the time to start the acceleration control or setting gradient information of the acceleration control to a lower value to reduce the extent of change of the acceleration control.
